(19) United States
(12) Patent Application Publication
(10) Pub. No.: US 2023/0342692 A1
(43) Pub. Date: Oct. 26, 2023

(54) CLIMATE RISK ASSESSMENT SYSTEMS AND METHODS

(71) Applicant: Actimize LTD., Ra'anana (IL)

(72) Inventors: Rituraj MISHRA, London (GB); Harshad SHINDE, Pune (IN); Aditya SAKURE, Amravati (IN); Shikha SAXENA, Pune (IN); Vidya NAIK, Pune (IN)

(21) Appl. No.: 17/729,700

(22) Filed: Apr. 26, 2022

(51) Int. Cl. G06Q 10/06

(52) U.S. Cl. CPC G06Q 10/0635

(57) ABSTRACT

Climate risk assessment systems and methods, and non-transitory computer readable media, include receiving climate data and profile data for a plurality of entities, wherein the plurality of entities are associated with an institution; calculating a physical risk score and a transition risk score of each of the plurality of entities based on the climate data and profile data; calculating an environmental risk score of each of the plurality of entities based on the physical risk score and the transition risk score of each of the plurality of entities; calculating a green index score of the institution from the environmental risk score of each of the plurality of entities; generating an alert when the green index score exceeds a predetermined green threshold; and performing an action to lower the green index score.

### TECHNICAL FIELD

The present disclosure relates generally to methods and systems for climate risk assessment, and more specifically relates to methods and systems that provide a climate risk assessment of the clients of, for example, a financial institution.

### BACKGROUND

It is increasingly important for companies, and in particular for banks to measure the financial risks related to climate change when entering financing transactions, such as lending, investing, etc. Financial regulators consider climate risk as an emerging risk, and banks are expected to incorporate climate risk in their risk management practices. For example, the U.K. and Europe are encouraging financial institutions to take a closer look at the financial system’s role in promoting environmentally clean economic growth and the transition to a global net-zero carbon emission economy.

Currently, there is an absence of a robust product or feature that provides a climate risk assessment of the clientele of banks and other financial institutions. Policymakers and regulators increasingly recognize climate change’s important implications for the financial sector. Climate change affects the financial system through two main channels - physical risk and transition risk.

Physical risks are event-driven or longer-term shifts in climate patterns. Physical risks arise from hazards, exposure, and vulnerability of a business due to climate impact, such as damage to property, infrastructure, and land due to cyclones and droughts. Transition risks relate to the financial and reputational risks associated with society transitioning to a low-carbon economy. Transition risks result from changes in regulatory compliance, climate policy, technology, and consumer and market sentiment during the adjustment to a lower-carbon economy.

Central banks and financial regulators increasingly acknowledge the financial stability implications of climate change. To measure the impact that sustainable investments have on their environmental targets, however, is challenging.

Accordingly, a need exists for improved systems and methods that will assist institutions, and particularly financial institutions to move toward green financing.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of a climate risk assessment system according to various aspects of the present disclosure.

FIG. 2 is a flowchart of a method according to embodiments of the present disclosure.

FIG. 3A is a flowchart of a method of calculating a physical risk score according to embodiments of the present disclosure.

FIG. 3B illustrates exemplary calculations for determining physical risk scores according to embodiments of the present disclosure.

FIG. 4A is a flowchart of a method of calculating a transition risk score according to embodiments of the present disclosure.

FIG. 4B illustrates exemplary calculations for determining transition risk scores according to embodiments of the present disclosure.

FIG. 5A is a flowchart of a method of calculating an environmental risk score and a green index score according to embodiments of the present disclosure.

FIG. 5B illustrates exemplary calculations for determining environmental risk scores and a green index score according to embodiments of the present disclosure.

FIG. 6 is a flowchart of a method of introducing the environment risk score as a risk factor in customer due diligence analysis according to embodiments of the present disclosure.

FIG. 7 is a flowchart of a method of adding the environmental risk score into a watchlist filtering score according to embodiments of the present disclosure.

FIG. 8 is a flowchart of a method of adding the environmental risk score into a suspicious activity monitoring score according to embodiments of the present disclosure.

FIG. 9 is a flowchart of a method of introducing the environmental risk score into a portfolio green score in sales practice analysis according to embodiments of the present disclosure.

FIG. 10 is a block diagram of a computer system suitable for implementing one or more components in FIG. 1 according to one embodiment of the present disclosure.

### DETAILED DESCRIPTION

This description and the accompanying drawings that illustrate aspects, embodiments, implementations, or applications should not be taken as limiting-the claims define the protected invention. Various mechanical, compositional, structural, user interface, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The present invention describes a robust feature to help institutions, such as banks, law firms, corporations, governments (local, regional, federal/national), and businesses, measure the physical risk score and the transition risk score of their clients, which will allow them to manage, allocate, and direct capital more efficiently towards green financing. In an exemplary embodiment, the institution is a financial institution. Examples of financial institutions include central banks, retail and commercial banks, credit unions, investment banks, investment companies, brokerage firms, insurance companies, and mortgage companies. Clients of an institution can include corporations (e.g., Microsoft, Apple, Amazon, Domino’s Pizza, Exxon Mobil, Google, General Motors Corporation, etc.), businesses (e.g., restaurants, dry cleaners, grocery stores, etc.), and individuals (e.g., Bill Gates, Oprah Winfrey, Barack Obama, Dwayne Johnson, etc.). In one or more embodiments, the physical risk score and/or the transition risk score can be integrated with existing financial crime and compliance (FC&C) solutions.

In some embodiments, the present methods and systems build modules or rules that address climate-related regulatory requirements and integrate client risk assessment in existing FC&C solutions. The present methods include data analysis of climate literature along with the flexibility of adding multiple and/or new data feeds from established data providers such as the World Bank, the International Monetary Fund (IMF), Climate Watch, and the Carbon Pricing Dashboard that can be individually selected and/or tailored by the institutional user. In various embodiments, the physical risk score and the transition risk score are calculated by also using profile data from existing FC&C solutions. Profile data can include the name of an entity, the type of business, products and/or services sold, financial information, data related to Know Your Customer (KYC) compliance, and/or any other data related to an entity. An entity can be an individual or a company.

The present methods and systems further enhance existing FC&C scoring capabilities by considering climate risk scoring, and also by providing dashboards and reporting. Finally, the present methods provide an alerting mechanism to mitigate risk because the final risk score will help financial institutions decide whether and how a financing might improve (or worsen) their green index.

The NICE Actimize® system is an example of an existing FC&C solution. The NICE Actimize® system provides cross-channel fraud prevention, anti-money laundering detection, and trading surveillance solutions that address such concerns as payment fraud, cybercrime, sanctions monitoring, market abuse, customer due diligence, and insider trading. In various embodiments, the present methods can be incorporated into the Anti-Money Laundering (AML) suite of the NICE Actimize® system. For example, in a customer due diligence (CDD) solution, the environmental risk score can be introduced as a risk factor; in a watchlist filtering (WLF) solution, a green contribution environmental list can be provided for watchlist filtering; and/or in suspicious activity monitoring (SAM), a new SAM rule can be added that detects suspicious activities of non-green businesses by monitoring transactions such as methane emissions. In another example, in monitoring compliance of financial markets, a sales practice rule that checks the green index of a portfolio for a customer compared to the customer’s green appetite can be added. Appetite refers to the willingness of an investor to bear risk typically in exchange for potential reward.

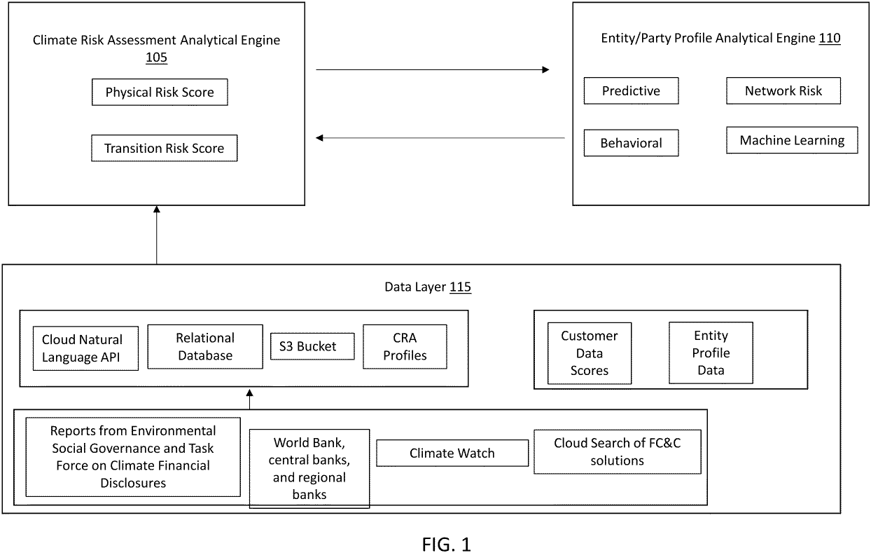

FIG. 1 illustrates a block diagram of the data flow between a climate risk assessment (CRA) analytical engine 105, an entity/party profile analytical engine 110 such as an analytical engine associated with the NICE Actimize® system, and data layer 115 according to embodiments of the present disclosure. CRA analytical engine 105 analyzes and processes data from data layer 115 and provides the physical risk score and the transition risk score for clients of an institution. Entity/party profile analytical engine 110 communicates with and exchanges data and profile analysis with CRA analytical engine 105. Both CRA analytical engine 105 and entity/profile analytical engine 110 fetch profile data for calculation of scores, such as from a database or data layer 115. In one embodiment, CRA analytical engine 105 fetches profile data of an entity when calculating a transition risk score. In some embodiments, entity/party analytical engine 110 fetches climate risk assessment profile data when calculating FC&C model scores.

As shown in the embodiment depicted in FIG. 1, entity/party profile analytical engine 110 includes predictive analytics, behavioral analytics, network risk assessment, and machine learning approaches to assist in profile analysis. Data layer 115 absorbs input data coming from sources such as government bodies, regulators, and private data agencies. As shown, data layer includes cloud natural language application programming interface (API), a relational database, an S3 bucket, CRA profiles, reports from environmental social governance (ESG) and from the task force on climate financial disclosures (TCFD), the World Bank, central banks, and regional banks, Climate Watch, Cloud Search of FC&C solutions, customer data scores, and entity profile data. The data fed from data layer 115 to CRA analytical engine 105 can be in any form, e.g., XML, CSV, images, PDF, reports, or databases, and are processed in a staging area. In one or more embodiments, a graphical user interface (not shown) acts as a presentation layer, and includes real-time dashboards, reports, indicators, and alert management.

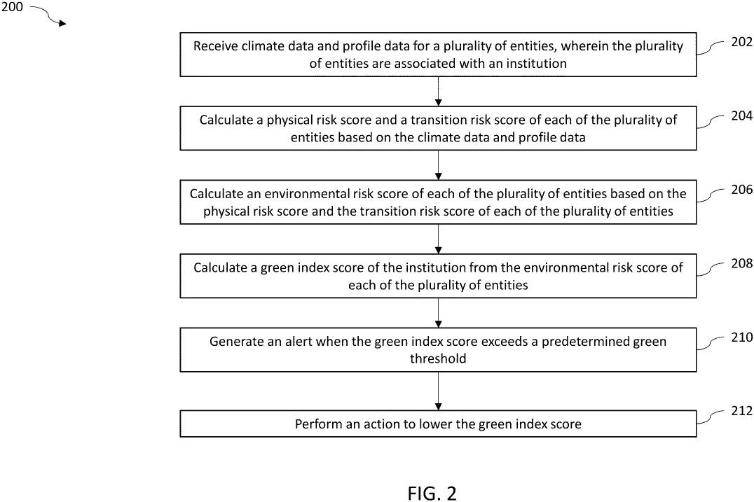

Referring now to FIG. 2, a method 200 according to embodiments of the present disclosure is described. At step 202, CRA analytical engine 105 receives climate data and profile data for a plurality of entities. Entities include individuals and parties such as businesses or countries. The entities are associated with an institution, for example, a financial institution such as a bank. In one or more embodiments, CRA analytical engine 105 receives the data from data layer 115.

At step 204, CRA analytical engine 105 calculates a physical risk score and a transition risk score of each of the plurality of entities based on the climate data and profile data received.

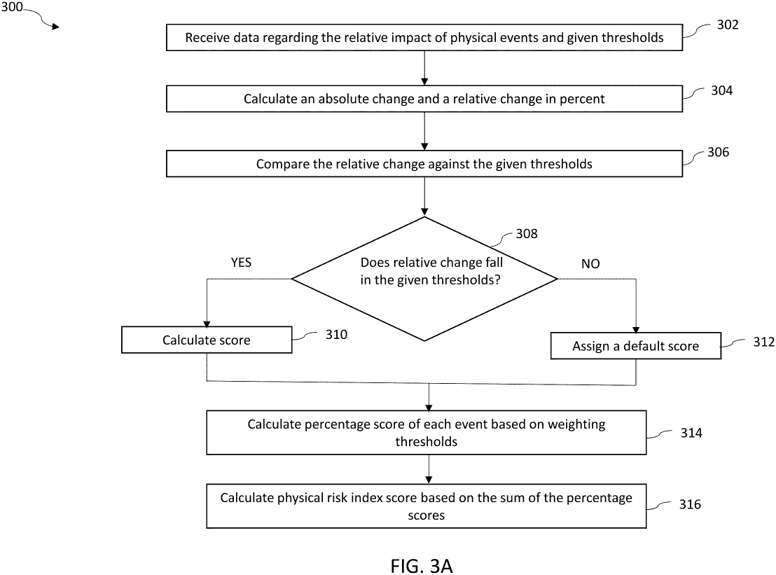

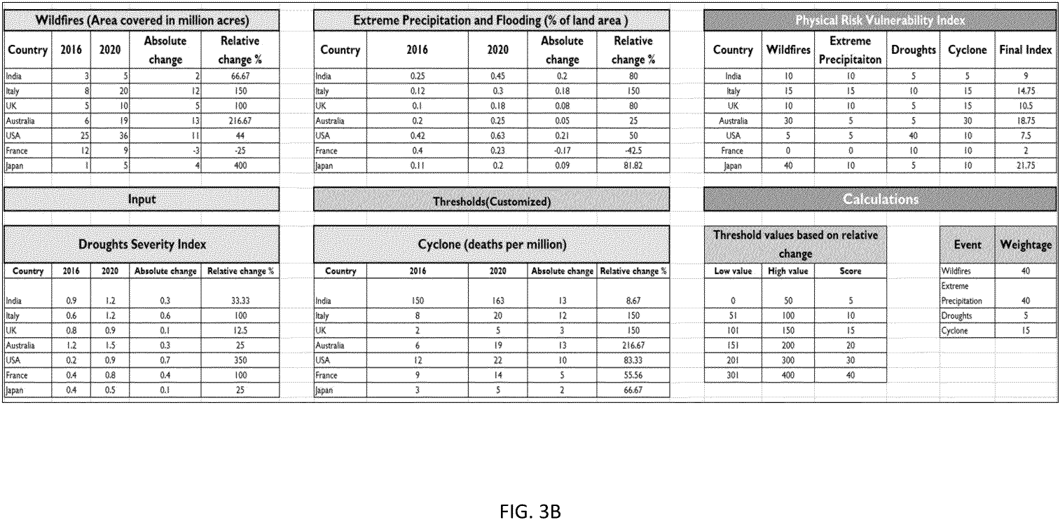

Referring to FIG. 3A, shown is a method 300 for calculating a physical risk score. At step 302, CRA analytical engine 105 receives data regarding the relative impact of physical events and given thresholds. The thresholds are customizable and are decided by the user. Referring now to FIG. 3B, exemplary physical events can include one or more of wildfires, droughts, extreme precipitation and flooding, tornadoes, lightning strikes, and cyclones/hurricanes.

At step 304, CRA analytical engine 105 calculates an absolute change and a relative change in percent in the physical events. FIG. 3B illustrates the calculation of absolute change and relative change in the different kinds of physical events.

At step 306, CRA analytical engine 105 compares the relative change against the given thresholds. If the relative change falls within the given thresholds in step 308, a score can be calculated in step 310. For example, in FIG. 3B, the relative change in percent for wildfires in India is 66.67%. Comparing 66.67% to the threshold values, India receives a score of 10 for wildfires since 66.67% falls in between 51-100%. If the relative change falls outside the given threshold, then a default score is assigned in step 312.

At step 314, CRA analytical engine 105 calculates the percentage score of each event based on weighting thresholds. As shown in FIG. 3B, the weight to be given to each physical event is provided. The score for wildfires is to be given 40% weight, the score for extreme precipitation is to be given 40%, the score for drought is to be given 5%, and for a cyclone is to be given 15%. So, taking India as the example, the percentage score for wildfires is 4 (10 x 0.4), the percentage score for extreme precipitation is 4 (10 x 0.4), the percentage score for drought is 0.25 (5 x 0.05), and the percentage score for cyclone is 0.75 (5 x 0.15).

At step 316, CRA analytical engine 105 calculates the physical risk index score (or the physical risk score) based on the sum of the percentage scores. Thus, the physical risk score for India is 4 + 4 + 0.25 + 0.75, which equals 9, as shown in FIG. 3B.

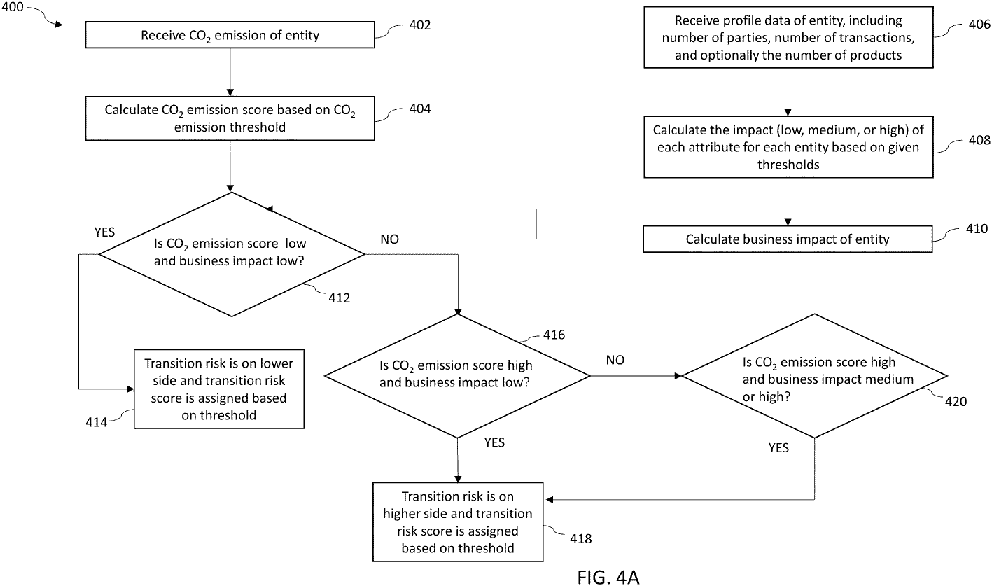

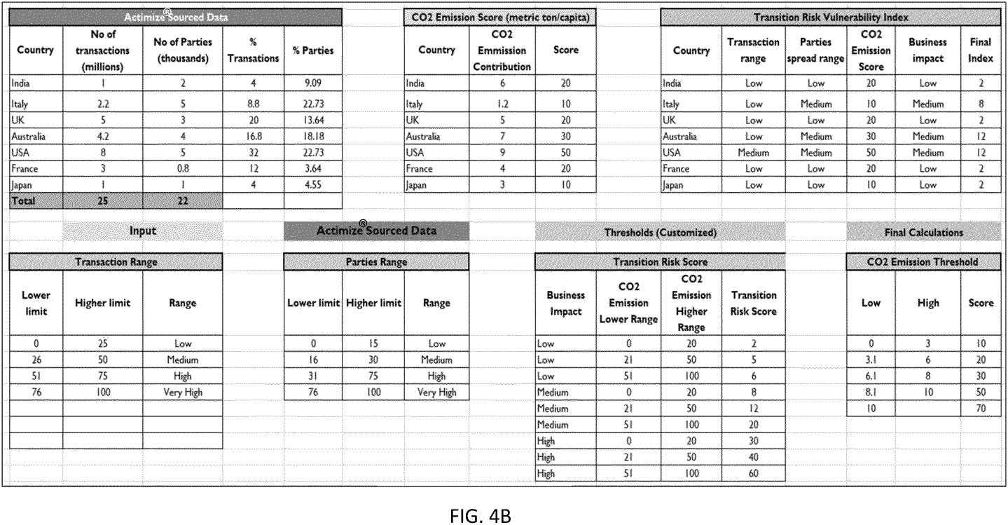

Referring now to FIG. 4A, shown is a method 400 of calculating the transition risk score. At step 402, CRA analytical engine 105 receives the carbon dioxide emissions (such as in metric tons/capita) of an entity. The entity may be a region, a country, a specific kind or nature of business, or any combination thereof.

At step 404, CRA analytical engine 105 calculates the carbon dioxide emission score based on the carbon dioxide emission threshold, which may be customized by a user. Referring now to FIG. 4B, for India, the carbon dioxide emission score is 20 since its emission contribution is 6, which is in between 3.1 and 6.

At step 406, CRA analytical engine 105 receives profile data of the entity, including the number of transactions, the number of parties, and optionally the number of products. As shown in FIG. 4B, the profile data, in one embodiment, may be sourced from the NICE Actimize® system. A variety of parameters from the NICE Actimize® profile can be used.

At step 408, CRA analytical engine 105 calculates the impact (low, medium, or high) of each attribute for each entity based on given thresholds, which may be customized by a user. For example, looking at India, the percent transactions is 4, which provides a low impact, and the percent parties is 9.09, which provides a low impact.

At step 410, CRA analytical engine 105 calculates the business impact of the entity. The transition risk of a business depends on the business volume that can be calculated using multiple attributes based on the profile data. For example, percentage of transactions per country and regional parties can be analyzed. In various embodiments, if any attribute impact is high, then the business impact is high, and if any attribute impact is medium, then the business impact is medium. For any other situation, the business impact is low. Looking at India, the transaction range and the parties spread range are both low, so the business impact of India is low in this example.

The business impact is then combined with the carbon dioxide emission score. At step 412, CRA analytical engine 105 determines whether the carbon dioxide emission score is low and the business impact is low. If the answer is yes, then the transition risk is on the lower side, and the transition risk score is assigned based on predetermined thresholds at step 414. For example, India has a carbon dioxide emission score of 20, which is in between 0 and 20, and is therefore assigned a transition risk score of 2.

If the answer is no, at step 416, CRA analytical engine 105 determines whether the carbon dioxide emission score is high and the business impact is low. The carbon dioxide emission score is low or high based on the carbon dioxide emission threshold. For example, as seen in FIG. 4B, a score of 10-30 may be considered low, while a score of 50-70 may be considered high. As discussed above, the carbon dioxide emission threshold is customizable by a user. If the answer is yes, the transition risk is on the higher side based on the transition risk threshold, and the transition risk score is assigned based on predetermined thresholds at step 418. For example, looking at the transition risk score threshold table in FIG. 4B, where the business impact is low, but the carbon dioxide emission score is between 51-100, the exemplary transition risk score that would be assigned is 6.

If the answer is no, at step 420, the CRA analytical engine 105 in step 418 determines whether the carbon dioxide emission score is high and the business impact is high or medium. If the answer is yes, then the transition risk is on the higher side, and the transition risk score is assigned based on predetermined thresholds. For example, referring to FIG. 4B, the USA has a carbon dioxide emission score of 50 and a business impact that is medium, and is assigned an exemplary transition risk score of 12, which is on the higher side of the range of transition risk scores.

In short, if the carbon dioxide emission score is low and the business impact is low, then the transition risk is generally low. If the carbon dioxide emission score is high and the business impact is low, then the transition risk is generally high. If the carbon dioxide emission score is high and the business impact is medium, then the transition risk is generally high. If the carbon dioxide emission score is high and the business impact is high, then the transition risk is generally high.

Referring back to FIG. 2 and method 200, at step 206, CRA analytical engine 105 calculates an environmental risk score of each of the plurality of entities based on the physical risk score and the transition risk score of each of the plurality of entities.

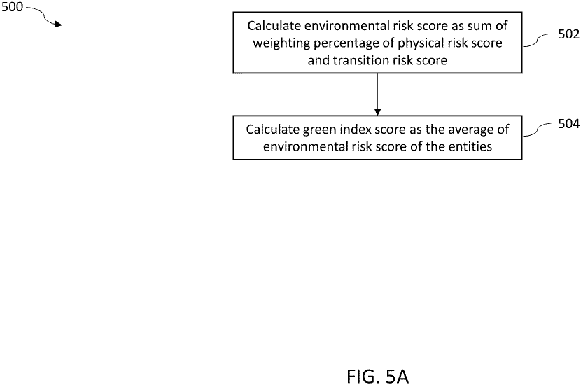

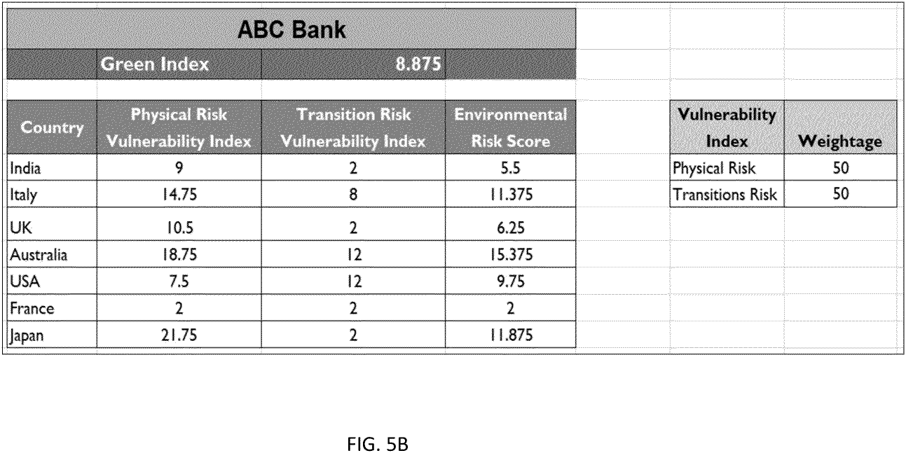

Referring now to FIG. 5A and method 500, at step 502, CRA analytical engine 105 combines the physical risk score of an entity and the transition risk score of an entity to calculate the environmental risk score. For example, the environmental risk score can be calculated as a sum of a weighting percentage of the physical risk score and the transition risk score. Referring to FIG. 5B, the weight to be given to the physical risk score is 50%, and the weight to be given to the transition risk score is 50%. Calculating the environmental risk score of India would be (9 x 0.5) + (2 x 0.5), which equals 5.5.

At step 208, CRA analytical engine 105 calculates a green index score for the institution from the environmental risk score of each of the plurality of entities that are associated with the institution. Referring back to FIG. 5B, at step 504, CRA analytical engine 105 calculates the green index score of the institution as the average of the environmental risk scores of the individual entities. In FIG. 5B, the average of the environmental risk scores of India, Italy, the UK, Australia, the USA, France, and Japan is taken to calculate the green index score of 8.875 for the financial institution ABC Bank. In alternative embodiments, the green index score can be based on a weighting percentage of each country’s environmental risk score.

At step 210, CRA analytical engine 105 generates an alert when the green index score of the institution exceeds a predetermined green threshold.

At step 212, CRA analytical engine 105 performs an action to lower the green index score.

In one embodiment, performing the action to lower the green index score includes obtaining an environmental score of an entity associated with the institution for a certain period of time (e.g., 5 years), calculating a contribution of the entity to the green index score of the institution, determining that the contribution of the entity exceeds a threshold contribution, and suggesting a remediation action to the institution. In one or more embodiments, the remediation action includes one or more of updating a climate risk assessment profile of the entity, restricting a product associated with the entity (e.g., sold by the entity), or stopping a business associated with the entity. In some embodiments, CRA analytical engine 105 verifies that the remediation actions were taken, and updates the climate risk assessment profile of the entity. If the contribution of the entity does not exceed the threshold contribution, the climate risk assessment profile of the entity can be updated, and the entity can continue business.

In certain embodiments, performing the action to lower the green index score includes obtaining the green index of the institution for a certain period of time (e.g., 3 years), obtaining a TCFD commitment of the institution, comparing the green index score of the institution for the certain period of time with the TCFD commitment, and plotting the green index score of the institution for the certain period of time versus the certain period of time to determine whether the institution is making progress in lowering the green index score of the institution.

In various embodiments, when the transition risk score is high for an entity and breaches a threshold, the environmental risk score of each of the plurality of entities associated with the institution is obtained, a combination of the plurality of entities that will reduce the transition risk score of the plurality of entities is determined, and this combination is provided to the institution. In some embodiments, the environmental risk score of the plurality of entities in a given region (e.g., by county, state, or multi-region state) is obtained. The combination of businesses that can reduce the transition risk is calculated, and the best possible combination of businesses can be suggested that meets the threshold.

In several embodiments, CRA analytical engine 105 stores the physical risk score of each of the plurality of entities, the transition risk score of each of the plurality of entities, the environmental risk score of each of the plurality of entities, and the green index score of the institution in a climate risk assessment profile of the institution.

In some embodiments, entity/party profile analytical engine 110 integrates the climate risk assessment profile of the institution into a FC&C analysis. For example, entity/party profile analytical engine 110 can integrate the environmental risk score of an entity from the plurality of entities into an FC&C model score and generate an alert when the FC&C model score exceeds a predetermined recommended threshold. The recommended threshold can be provided by the institution or by a third party, such as a financial regulatory entity.

As discussed in more detail below, in some embodiments, integration can include introducing the environmental risk score as a risk factor in CDD analysis; adding the environmental risk score into a WLF score; adding the environmental risk score into a SAM score; or introducing the environmental risk score into a portfolio green score in sales practice analysis; or a combination thereof.

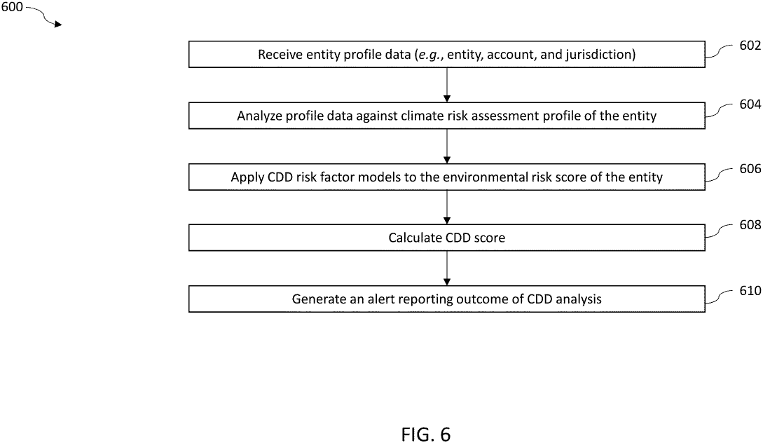

Referring now to FIG. 6, illustrated is a method 600 of integrating the climate risk assessment profile into a CDD analysis. CDD refers to the act of collecting identifying information in order to verify a customer’s identity and more accurately assess the level of, e.g., criminal risk they present. CDD is a foundation of the Know Your Customer (KYC) process and Anti-Money Laundering (AML), which requires companies to understand who their customers are, their financial behavior, and what kind of money laundering or terrorism financing risk they present. It is designed to help banks and financial institutions minimize, track, and/or prevent financial crimes like money laundering, terrorist financing, human and drug trafficking, and fraud.

At step 602, entity/party profile analytical engine 110 receives entity profile data, such as the name of an entity, an account number, and a jurisdiction or location. At step 604, entity/party profile analytical engine 110 analyzes the entity profile data against the climate risk assessment profile of the entity, including the environmental risk score of the entity. At step 606, entity/party profile analytical engine 110 applies CDD risk factor models to the environmental risk score of the entity. At step 608, entity/party profile analytical engine 110 calculates a CDD score for the entity, e.g., a score indicating the level of criminal risk the entity presents, such as low risk, medium risk, or high risk. At step 610, entity/party profile analytical engine 110 and/or CRA analytical engine 105 generate an alert (a CDD alert, a CRA alert, or both) reporting the outcome of the CDD analysis. In various embodiments, entity/party profile analytical engine 110 generates an alert when the CDD score exceeds a predetermined recommended threshold.

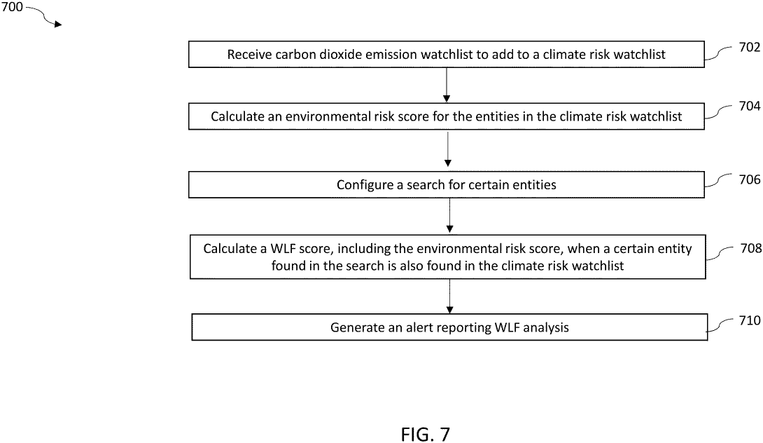

Referring now to FIG. 7, illustrated is a method 700 of integrating the climate risk assessment profile into a WLF analysis. Generally, WLF screens customers, related parties, and transactions against sanctions list, and identifies politically exposed person (PEPs), and other high-risk individuals and organizations to avoid transactions with sanctioned entities or embargoed goods.

At step 702, CRA analytical engine 105 receives a carbon dioxide emission watchlist from global institutes to add to a climate risk watchlist. At step 704, CRA analytical engine 105 calculates an environmental risk score for the entities in the climate risk watchlist. At step 706, CRA analytical engine 105 configures a search for certain entities (e.g., entities with an environmental risk score greater than 20).

At step 708, if there is a hit or a match, or in other words, if a certain entity found in the search is also found in the climate risk watchlist (e.g., an entity with an environmental risk score greater than 20), entity/party profile analytical engine 110 calculates a WLF score (e.g., a customer risk score), which includes the environmental risk score. At step 710, entity/party profile analytical engine 110 generates an alert reporting its WLF analysis and/or CRA analytical engine 105 generates a climate risk assessment alert. In various embodiments, entity/party profile analytical engine 110 generates an alert when the WLF score exceeds a predetermined recommended threshold.

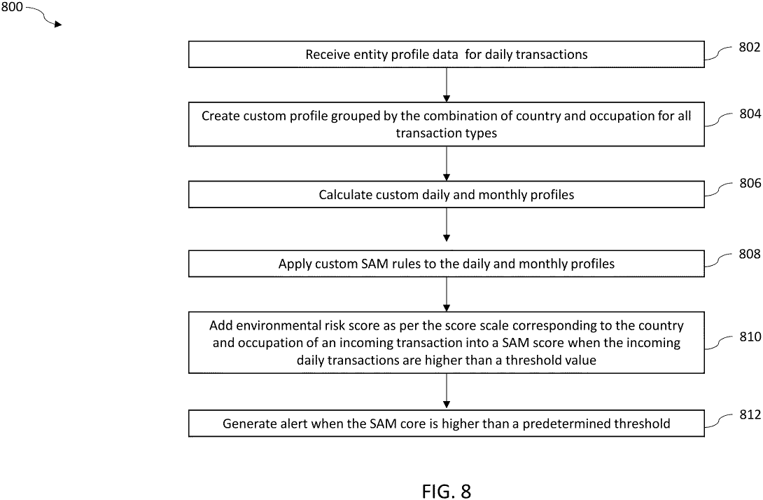

Referring now to FIG. 8, illustrated is a method 800 of integrating the climate risk assessment profile into a SAM analysis. SAM is the procedure of identifying, researching, documenting—and, if necessary, reporting—a customer’s banking pattern when it indicates possible illegal behavior. Examples of suspicious activity include unusual large business deposits of cash, personal accounts with suspicious activity, and avoidance of a currency transaction report.

At step 802, entity/party profile analytical engine 110 receives entity profile data for daily transactions, such as cash or amount of money transferred, entities involved (including type of business or occupation), and countries involved. At step 804, entity/party profile analytical engine 110 creates a custom profile grouped by the combination of country and occupation for all transaction types. At step 806, entity/party profile analytical engine 110 calculates custom daily and monthly profiles for each entity.

At step 808, entity/party profile analytical engine 110 applies custom SAM rules to the daily and monthly profiles. At step 810, entity/party profile analytical engine 110 adds the environmental risk score as per the score scale corresponding to the country and the occupation of an incoming transaction into a SAM score when the incoming daily transactions are higher than a threshold value. At step 812, entity/party profile analytical engine 110 entity/party profile engine 110 generates a custom alert when the SAM score is higher than a predetermined threshold.

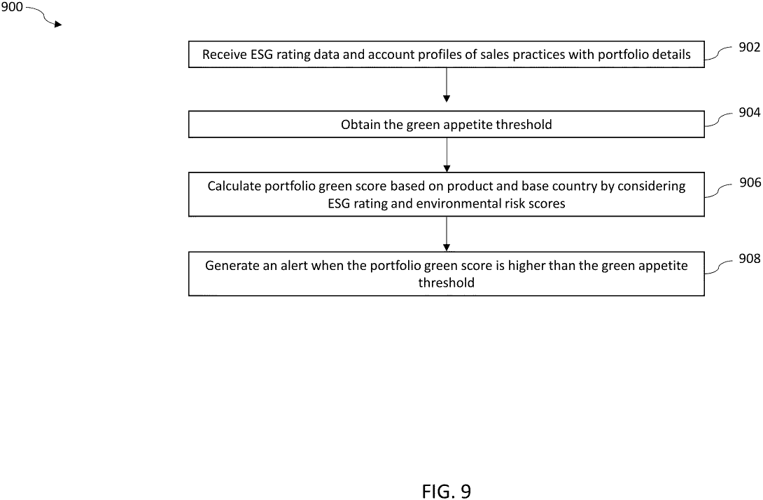

Referring now to FIG. 9, illustrated is a method 900 of integrating the climate risk assessment profile into a sales practice analysis. Monitoring of sales practice helps firms meet current and future global regulatory requirements and ensure investment recommendations are consistent with each client’s investment and suitability profiles. Analysis of sales practice ensures wealth management firms and registered investment advisors are properly managing investor wealth and are complying with financial regulatory requirements.

At step 902, CRA analytical engine 105 receives ESG ratings and account profiles of sales practices with portfolio details. At step 904, CRA analytical engine 105 obtains the green appetite threshold, or the willingness of investors to bear financial risk, for the portfolios. At step 906, CRA analytical engine 105 calculates the green score of a portfolio based on product and base country by considering the ESG rating data and the environmental risk score of the entities involved. At step 908, CRA analytical engine 105 and/or entity profile analytical engine 110 generate an alert (sales practice alert, climate risk assessment alert, or both) when the green score of the portfolio is higher than the green appetite threshold.

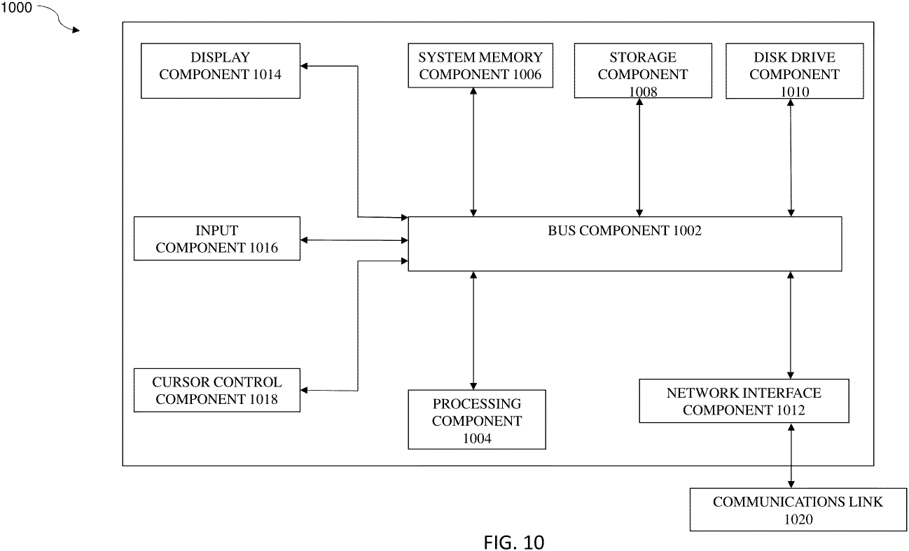

Referring now to FIG. 10, illustrated is a block diagram of a system 1000 suitable for implementing embodiments of the present disclosure. System 1000, such as part a computer and/or a network server, includes a bus 1002 or other communication mechanism for communicating information, which interconnects subsystems and components, including one or more of a processing component 1004 (e.g., processor, micro-controller, digital signal processor (DSP), etc.), a system memory component 1006 (e.g., RAM), a static storage component 1008 (e.g., ROM), a network interface component 1012, a display component 1014 (or alternatively, an interface to an external display), an input component 1016 (e.g., keypad or keyboard), and a cursor control component 1018 (e.g., a mouse pad).

In accordance with embodiments of the present disclosure, system 1000 performs specific operations by processor 1004 executing one or more sequences of one or more instructions contained in system memory component 1006. Such instructions may be read into system memory component 1006 from another computer readable medium, such as static storage component 1008. These may include instructions to receive, climate data and profile data for a plurality of entities, wherein the plurality of entities are associated with an institution; calculate a physical risk score and a transition risk score of each of the plurality of entities based on the climate data and profile data; calculate an environmental risk score of each of the plurality of entities based on the physical risk score and the transition risk score of each of the plurality of entities; calculate a green index score of the institution from the environmental risk score of each of the plurality of entities; generate an alert when the green index score exceeds a predetermined green threshold; and perform an action to lower the green index score. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 1004 for execution. Such a medium may take many forms, including but not limited to, non-volatile media, volatile media, and transmission media. In various implementations, volatile media includes dynamic memory, such as system memory component 1006, and transmission media includes coaxial cables, copper wire, and fiber optics, including wires that comprise bus 1002. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 1000. In various other embodiments, a plurality of systems 1000 coupled by communication link 1020 (e.g., LAN, WLAN, PTSN, or various other wired or wireless networks) may perform instruction sequences to practice the disclosure in coordination with one another. Computer system 1000 may transmit and receive messages, data, information and instructions, including one or more programs (i.e., application code) through communication link 1020 and communication interface 1012. Received program code may be executed by processor 1004 as received and/or stored in disk drive component 1010 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A climate risk assessment system comprising:
a processor and a computer readable medium operably coupled thereto, the computer readable medium comprising a plurality of instructions stored in association therewith that are accessible to, and executable by, the processor, to perform operations which comprise:
receiving climate data and profile data for a plurality of entities, wherein the plurality of entities are associated with an institution;
calculating a physical risk score and a transition risk score of each of the plurality of entities based on the climate data and profile data;
calculating an environmental risk score of each of the plurality of entities based on the physical risk score and the transition risk score of each of the plurality of entities;
calculating a green index score of the institution from the environmental risk score of each of the plurality of entities;
generating an alert when the green index score exceeds a predetermined green threshold; and
performing an action to lower the green index score.

2. The climate risk assessment system of claim 1, wherein the institution comprises a financial institution.

3. The climate risk assessment system of claim 1, wherein performing an action to lower the green index score comprises:
obtaining an environmental score of an entity associated with the institution for a certain period of time;
calculating a contribution of the entity to the green index score of the institution;
determining that the contribution of the entity exceeds a threshold contribution; and
suggesting a remediation action to the institution.

4. The climate risk assessment system of claim 3, wherein the remediation action comprises one or more of:
updating a climate risk assessment profile of the entity;
restricting a product associated with the entity; or
stopping a business associated with the entity.

5. The climate risk assessment system of claim 1, wherein performing an action to lower the green index score comprises:
obtaining the green index score of the institution for a certain period of time;
obtaining a task force on climate-financial disclosure (TCFD) commitment of the institution;
comparing the green index score of the institution for the certain period of time with the TCFD commitment; and
plotting the green index score of the institution for the certain period of time versus the certain period of time to determine whether the institution is making progress in lowering the green index score of the institution.

6. The climate risk assessment system of claim 1, wherein performing an action to lower the green index score comprises:
obtaining an environmental risk score of each of the plurality of entities associated with the institution;
determining a combination of the plurality of entities that will reduce the transition risk score of the plurality of entities; and
providing the combination to the institution.

7. The climate risk assessment system of claim 1, wherein the operations further comprise storing the physical risk score of each of the plurality of entities, the transition risk score of each of the plurality of entities, the environmental risk score of each of the plurality of entities, and the green index score of the institution in a climate risk assessment profile of the institution.

8. The climate risk assessment system of claim 7, wherein the operations further comprise integrating the climate risk assessment profile of the institution into a financial compliance and crime (FC&C) analysis.

9. The climate risk assessment system of claim 8, wherein integrating the climate risk assessment profile of the institution into the FC&C analysis comprises:
integrating the environmental risk score of an entity from the plurality of entities into an FC&C model score; and
generating an alert when the FC&C model score exceeds a predetermined recommended threshold.

10. The climate risk assessment system of claim 9, wherein integrating the environmental risk score of an entity from the plurality of entities into an FC&C model score comprises one or more of:
introducing the environmental risk score as a risk factor in customer due diligence (CDD) analysis;
adding the environmental risk score into a watchlist filtering (WLF) score;
adding the environmental risk score into a suspicious activity monitoring (SAM) score; or
introducing the environmental risk score into a portfolio green score in sales practice analysis.

11. A method of assessing climate risk, which comprises:
receiving climate data and profile data for a plurality of entities, wherein the plurality of entities are associated with an institution;
calculating a physical risk score and a transition risk score of each of the plurality of entities based on the climate data and profile data;
calculating an environmental risk score of each of the plurality of entities based on the physical risk score and the transition risk score of each of the plurality of entities;
calculating a green index score of the institution from the environmental risk score of each of the plurality of entities;
generating an alert when the green index score exceeds a predetermined green threshold; and
performing an action to lower the green index score.

12. The method of claim 11, wherein performing an action to lower the green index score comprises:
obtaining an environmental score of an entity from the plurality of entities associated with the institution for a certain period of time;
calculating a contribution of the entity to the green index score of the institution;
determining that the contribution of the entity exceeds a threshold contribution; and
suggesting a remediation action to the institution.

13. The method of claim 11, wherein performing an action to lower the green index score comprises:
obtaining the green index score of the institution for a certain period of time;
obtaining a task force on climate-financial disclosure (TCFD) commitment of the institution;
comparing the green index score of the institution for the certain period of time with the TCFD commitment; and
plotting the green index score of the institution for the certain period of time versus the certain period of time to determine whether the institution is making progress in lowering the green index score of the institution.

14. The method of claim 11, wherein performing an action to lower the green index score comprises:
obtaining the environmental score of each of the plurality of entities associated with the institution;
determining a combination of the plurality of entities that will reduce the transition risk score of the plurality of entities; and
providing the combination to the institution.

15. The method of claim 11, which further comprises:
storing the physical risk score of each of the plurality of entities, the transition risk score of each of the plurality of entities, the environmental risk score of each of the plurality of entities, and the green index score of the institution in a climate risk assessment profile of the institution; and
integrating the climate risk assessment profile of the institution into a financial compliance and crime (FC&C) analysis.

16. The method of claim 15, wherein integrating the climate risk assessment profile of the institution into the FC&C analysis comprises:
integrating the environmental risk score of an entity from the plurality of entities into an FC&C model score; and
generating an alert when the FC&C model score exceeds a predetermined recommended threshold.

17. The method of claim 16, wherein integrating the environmental risk score of an entity from the plurality of entities into an FC&C model score comprises one or more of:
introducing the environmental risk score as a risk factor in customer due diligence (CDD) analysis;
adding the environmental risk score into a watchlist filtering (WLF) score;
adding the environmental risk score into a suspicious activity monitoring (SAM) score; or
introducing the environmental risk score into a portfolio green score in sales practice analysis.

18. A non-transitory computer-readable medium having stored thereon computer-readable instructions executable by a processor to perform operations which comprise:
receiving climate data and profile data for a plurality of entities, wherein the plurality of entities are associated with an institution;
calculating a physical risk score and a transition risk score of each of the plurality of entities based on the climate data and the profile data;
calculating an environmental risk score of each of the plurality of entities based on the physical risk score and the transition risk score of each of the plurality of entities
calculating a green index score of the institution from the environmental risk score of each of the plurality of entities;
generating an alert when the green index score exceeds a predetermined green threshold; and
performing an action to lower the green index score.

19. The non-transitory computer-readable medium of claim 18, wherein the operations further comprise:
storing the physical risk score of each of the plurality of entities, the transition risk score of each of the plurality of entities, environmental risk score of each of the plurality of entities, and the green index score of the institution in a climate risk assessment profile of the institution; and
integrating the climate risk assessment system profile of the institution into a financial compliance and crime (FC&C) analysis.

20. The non-transitory computer-readable medium of claim 19, wherein integrating the climate risk assessment profile for the institution into the FC&C analysis comprises:
integrating the environmental risk score of an entity from the plurality of entities into an FC&C model score; and
generating an alert when the FC&C model score exceeds a predetermined recommended threshold.
